(19) United States
(12) Patent Application Publication
(10) Pub. No.: US 2026/0218641 A1
(43) Pub. Date: Jul. 30, 2026

(54) L-SHAPED MIXING AND EVAPORATION DEVICE

(71) Applicant: DINEX A/S, Middelfart (DK)

(72) Inventors: Toni Eero Mikael KORHONEN, Middelfart (DK); Søren HANSEN, Middelfart (DK); Jim Elkjaer BEBE, Middelfart (DK); Mahipat Balwant RANAWAT, Middelfart (DK)

(73) Assignee: DINEX A/S, Middelfart (DK)

(21) Appl. No.: 19/141,650

(22) PCT Filed: Dec. 19, 2023
(86) PCT No.: PCT/EP2023/086625

§ 371 Date: Jun. 20, 2025

(30) Foreign Application Priority Data
Dec. 21, 2022 (EP) 22215347.0

(51) Int. Cl. F01N 3/28; B01F 23/213; B01F 25/00; B01F 25/10; B01F 25/313; F01N 3/20

(52) U.S. Cl. CPC F01N 3/2892; B01F 23/213; B01F 25/102; B01F 25/3131; F01N 3/2066; B01F 2025/913; F01N 2240/20; F01N 2610/02

(57) ABSTRACT

The present invention relates to an evaporation and gas mixing device for an exhaust gas after-treatment system, the device is for mixing an exhaust gas stream from the exhaust gas after-treatment system with an evaporated reductant.

### FIELD

The present invention relates to a liquid evaporation and gas mixing device for an exhaust gas after-treatment system, the device is for mixing an exhaust gas stream from a combustion engine with an evaporated reductant. Moreover, the present invention concerns an after-treatment system of the exhaust gases from a combustion engine wherein the device is incorporated. Furthermore, the present invention relates to a vehicle comprising the device of the present invention as well as the after-treatment system. The present invention also concerns use of the device of the present invention for mixing an exhaust gas stream from a combustion engine with an evaporated liquid reductant.

### BACKGROUND

Achieving effective evaporation of aqueous urea solution coming from dosing modules, homogenous mixing of the resulting reductant products like ammonia into the exhaust gas, and thereafter homogenous distribution over the catalytic components is a known challenge in the field of exhaust gas after-treatment systems. Several inventions have been proposed to achieve this, while minimizing risk of urea deposits, minimizing backpressure, and minimizing space requirement. Exhaust gas after-treatment systems comprising Selective Catalytic Reduction (SCR) systems may be included downstream of a combustion engine to remove or reduce nitrogen oxides (NOx) emissions coming from an engine. SCR systems include the introduction of a reductant to the exhaust gas stream. Mixers are added to help evaporate, decompose, and mix the reductant in the exhaust stream. Thorough mixing may help the performance by ensuring a homogeneous distribution of reductant, which enables the catalytic reactions to elapse uniformly across the cross section of the catalyst, thus minimizing ammonia slip and NOx emitted. US2010139258 relates to exhaust mixing systems, and more particularly to mixing systems for SCR systems. International patent application PCT/EP2019/061541 relates to a different mixing device involving a device for evaporating liquid spray and subsequent mixing into exhaust gases from a combustion engine comprising a housing which housing comprises a flow guiding device located within the housing.

### SUMMARY

The present invention solves many of the problems with the prior art mixing systems for after-treatment systems, while differentiating itself from existing mixing systems. The result is a compact mixing system that meets the functionality requirements but is also simple to manufacture, can be employed with axial dosing administered from top part, and can be scaled for different catalyst diameters. The present invention concerns a new compact, L-shaped evaporation and gas mixing device which is directed at forming a part of the exhaust after-treatment system of a vehicle. Effective evaporation of aqueous urea droplets coming from dosing modules, homogenous mixing of these evaporated urea components and consequent reductant products like ammonia into the exhaust gas, and thereafter homogenous distribution over the catalytic components is a known problem in the field of invention, which is now solved by the present invention. Multitude of inventions have been proposed to achieve this, while minimizing risk of urea deposits, minimizing backpressure and minimizing space requirement. It is intended in the after-treatment system that noxious exhaust gas out of vehicle engines passes through an oxidation catalyst, such as a Diesel Oxidation Catalyst (DOC) and/or a particulate filter, such as a Diesel Particulate Filter (DPF) and then into the compact exhaust gas mixing device of the present invention.

Proposed invention achieves all the above, while differentiating itself from existing inventions. The result is a compact mixing system that meets the functionality requirements, can be employed with multiple different dosing modules and can be scaled for different catalyst diameters.

The mixing device of the invention allows a liquid reductant, such as aqueous urea solution, to evaporate and subsequently mixes the evaporated reductant with exhaust gas while minimizing space requirements in the direction of exhaust gas flow through an exhaust gas after-treatment system comprising the device of the invention. The device permits an exhaust gas after-treatment system comprising the device of the invention to spread an improved mixture of exhaust gas and reductant across the face of a Selective Catalytic reduction (SCR) for reduction of NOx to harmless nitrogen and water. In this respect, aqueous urea solution is injected under pressure into the mixing system via the reductant dosing module to form a liquid spray which is exposed to a rapidly moving exhaust gas stream in the device, thus enhancing evaporation.

In a first aspect the present invention relates to an evaporation and gas mixing device for an exhaust gas after-treatment system, the device is for mixing an exhaust gas stream from the exhaust gas after-treatment system with an evaporated reductant, the device comprising:
a) a housing having an upstream inlet for receiving the exhaust gas stream and a downstream outlet for distributing the exhaust gas stream after mixing with the evaporated reductant,
b) a mixing chamber located inside the housing for swirling the exhaust gas stream and evaporated reductant for mixing inside the chamber having at least one opening for introducing the reductant into the mixing chamber and having at least two separate inlets for receiving the exhaust gas stream and at least one outlet in communication with the downstream outlet of the housing for distributing the exhaust gas stream after mixing with the evaporated reductant,
c) a dosing module for introducing the reductant through the at least one opening into the mixing chamber for evaporation and mixing with the exhaust gas stream, wherein the dosing module is arranged at one end of the mixing chamber opposite the at least one outlet of the mixing chamber,
d) a first guiding means located inside the housing having at least one inlet adapted to receive and guide the exhaust gas stream to the mixing chamber, wherein said exhaust gas stream is guided perpendicular to the exhaust gas stream being distributed out of the at least one outlet of the mixing chamber,
e) a second guiding means located inside the housing and arranged at the one end of the mixing chamber opposite the at least one outlet of the mixing chamber, said second guiding means having at least one inlet adapted to receive and guide the exhaust gas stream to the mixing chamber, wherein said exhaust gas stream is guided perpendicular to the exhaust gas stream being distributed out of the at least one outlet of the mixing chamber, and wherein the second guiding means has an opening for introducing the reductant into the mixing chamber.

In an embodiment the mixing chamber is adapted to swirl the exhaust gas stream clockwise and/or counter clockwise inside the mixing chamber. Typically, the mixing chamber is adapted to swirl the exhaust gas stream clockwise and counter clockwise inside the mixing chamber simultaneously.

In a further embodiment the first guiding means comprises at least one bypass opening for guiding a part of the exhaust gas stream directly to the downstream outlet of the housing thereby bypassing the mixing chamber.

In a still further embodiment the first guiding means comprises a cylindrical tube with multiple openings adapted to induce swirling of the exhaust gas stream, the cylindrical tube being located on an outer periphery of the mixing chamber. In one alternative the first guiding means induces swirling of the exhaust gas stream clockwise inside the mixing chamber and the second guiding means induces swirling of the exhaust gas stream counter clockwise inside the mixing chamber. In another the first guiding means induces swirling of the exhaust gas stream counter clockwise inside the mixing chamber and the second guiding means induces swirling of the exhaust gas stream clockwise inside the mixing chamber.

In another embodiment the first guiding means comprises a spiral shaped tube with at least one opening adapted to induce swirling of the exhaust gas stream, the spiral shaped tube being located on an outer periphery of the mixing chamber. In one alternative the first guiding means induces swirling of the exhaust gas stream clockwise inside the mixing chamber and the second guiding means induces swirling of the exhaust gas stream counter clockwise inside the mixing chamber. In another the first guiding means induces swirling of the exhaust gas stream counter clockwise inside the mixing chamber and the second guiding means induces swirling of the exhaust gas stream clockwise inside the mixing chamber.

In a still further embodiment the second guiding means is located at one end of the mixing chamber directly opposite the outlet of the mixing chamber and creating a space being a part of the mixing chamber.

In a further embodiment the mixing chamber defines a longitudinal axis from the at least one opening for introducing the reductant into the mixing chamber to the at least one outlet in communication with the downstream outlet of the housing for distributing the exhaust gas stream after mixing with the evaporated reductant.

In a still further embodiment the mixing chamber comprises a cylindrical tube with multiple openings in the upper part of the mixing chamber adjacent the dosing module.

In a further embodiment the housing is L-shaped having the upstream inlet for receiving the exhaust gas stream and the downstream outlet for distributing the exhaust gas stream after mixing with the evaporated reductant, wherein said upstream inlet defines a first longitudinal axis and said downstream outlet defining a second longitudinal axis, wherein the first longitudinal axis is substantially perpendicular to the second longitudinal axis.

In a still further embodiment the dosing module for introducing the reductant is arranged for introducing the reductant in parallel with the longitudinal axis of the mixing chamber.

In a further embodiment the dosing module selected from a pressure atomizer or an air-assisted atomizer.

In a still further embodiment the dosing module further comprises an injection protection attachment.

In a further embodiment the device of the present invention comprises a spray breaking device for impingement of a liquid spray.

In an embodiment the evaporated liquid reductant is an evaporated aqueous urea solution.

In a second aspect the present invention relates to an after-treatment system of the exhaust gases from a combustion engine characterised in that it comprises at least one device of the present invention as well as any one of the above embodiments.

In an embodiment of the second aspect the after-treatment system further comprises a particulate filter. Typically, a DPF.

In a further embodiment of the second aspect the after-treatment system further comprises a SCR catalyst.

In a still further embodiment of the second aspect the after-treatment system further comprises an Oxidation Catalyst, such as a DOC.

In a further embodiment of the second aspect the after-treatment system further comprises an Ammonia Slip Catalyst.

In a third aspect the present invention relates to use of at least one device of the present invention as well as any one of the above embodiments for mixing an exhaust gas stream from a combustion engine with an evaporated liquid reductant.

In an embodiment the combustion engine is a Diesel engine.

In another embodiment the combustion engine is an Otto engine.

In a further embodiment the combustion engine is an Atkinson engine.

In a fourth aspect the present invention relates to a vehicle characterised in that it comprises an after-treatment system of the present invention as well as any one of the above embodiments.

In an embodiment the vehicle is powered by a Diesel engine.

In another embodiment the vehicle is powered by an Otto engine.

In a further embodiment the vehicle is powered by an Atkinson engine.

In a further aspect the present invention relates to use of at least one device of the present invention as well as any one of the above embodiments in connection with construction of an after-treatment system for exhaust gas.

Further objects and advantages of the present invention will appear from the following description, and claims.

### BRIEF DESCRIPTION OF DRAWINGS

FIG. 1 is an exploded view illustrating individual components and subassemblies of an embodiment of an evaporation and gas mixing device of the invention.

FIG. 2 illustrates an evaporation and gas mixing device of the present invention seen as a 3D like cross section inside a housing for receiving exhaust gas to be processed and mixed.

FIG. 3 is a cross sectional view of the liquid evaporation and gas mixing device of the present invention as shown in FIGS. 1 and 2.

FIG. 4A illustrates, the embodiment in FIG. 1 wherein the conical top part is connected and sealed to the bottom part of the mixing chamber.

FIG. 4B illustrates an alternative to the embodiment in FIG. 4A.

FIG. 5A illustrates, is a top cross sectional view of the liquid evaporation and gas mixing device of the present invention as shown in FIGS. 1 and 2.

FIG. 5B illustrates is an alternative to the embodiment in FIG. 5A.

### DETAILED DESCRIPTION

There are many advantages of the present invention in a broad context as well as further even more advantages aspects of the embodiments.

Achieving effective evaporation of a liquid reductant, such as aqueous urea solution, coming from dosing modules, homogenous mixing of the resulting reductant products like ammonia into the exhaust gas, and thereafter homogenous distribution over the catalytic components is a known problem in the field of the invention. Several of the prior art devices have been proposed to achieve this, while minimizing risk of urea deposits, minimizing backpressure and minimizing space requirement.

The present invention provides improvements over the prior art, while differentiating itself from existing devices, by the construction herein detailed. The result is a compact mixing system that meets desired functionality requirements, but is also simple to manufacture, can be employed with multiple different dosing modules, with axial dosing, with multiple dosing modules, and can be scaled for different catalyst diameters.

The term “a reductant” as used herein refers to a reductant, such as a liquid reductant, such as an aqueous urea solution suitable for reducing the noxious gases from a combustion engine, such as a DEF (Diesel Exhaust Fluid).

The term “a longitudinal axis” as used herein refers to a fictive axis inside the housing defining the orientation of the housing for exhaust gas flow.

The term “an opening” as used herein refers to openings of any dimension as long as they are sufficiently large to aid flow through of exhaust gas streams, such as circular, polygonal, or other openings.

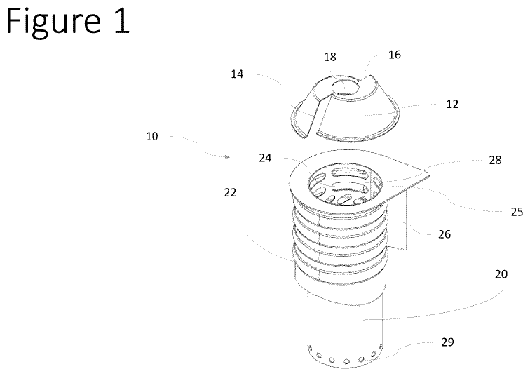

The method and device according to the present invention will now be described in more detail with regard to the accompanying FIGS. 1, 2, 3, 4A, 4B, 5A, 5B (hereinafter FIGS. 1-5). The figures show one way of implementing the present invention and is not to be construed as being limiting the present invention in any way.

All parts as shown in FIGS. 1-5 can be produced by rolling the outer spirals and inner tubes can be produced by laser cutting and rolling, the caps can be produced by deep drawing and the bottoms can be laser cut. Finally, the components can be joined together using welding, brazing, or any other secure attachment method known to one skilled in the art. Housing (32) can be produced by deep drawing.

Material to be used can be stainless steel that has low thermal expansion, urea corrosion resistant and having good formability and weldability.

FIG. 1 is an exploded view illustrating individual components and subassemblies of an embodiment of an evaporation and gas mixing device of the invention. The evaporation and gas mixing device (10) is composed of a conical top part (12), a mixing chamber defined by a cylindrical tube (20) and wherein the upper part of the mixing chamber in direct communication with the conical top part is enveloped by an outer spiral (20) where the outer spiral induces the counter clockwise swirling gas stream inside the mixing chamber. The conical top part (12) has two inlets (14, 16) for receiving the exhaust gas and an opening (18) in the top part for introducing the reductant during operation. In particular, the conical top part (12) is designed to keep nozzle tip clean. The mixing chamber has an inner cylindrical tube (20) with apertures (24) in the upper part and is enveloped by a spiral outer part (22) in the upper part adapted to receive the exhaust gas via inlet (26) into the spiral outer part, where the exhaust gas is swirled into the mixing chamber through the apertures (24) in the upper part. Further, provided is a delimiting body (25) separating the exhaust gas into a flow through the top part (12) and another flow through the inlet (26) into the mixing chamber. At the end where exhaust gas stream leaves the mixing chamber through holes (29) are provided to help keep the trailing edge of the cylindrical tube (20) clean of trapped liquid reductant.

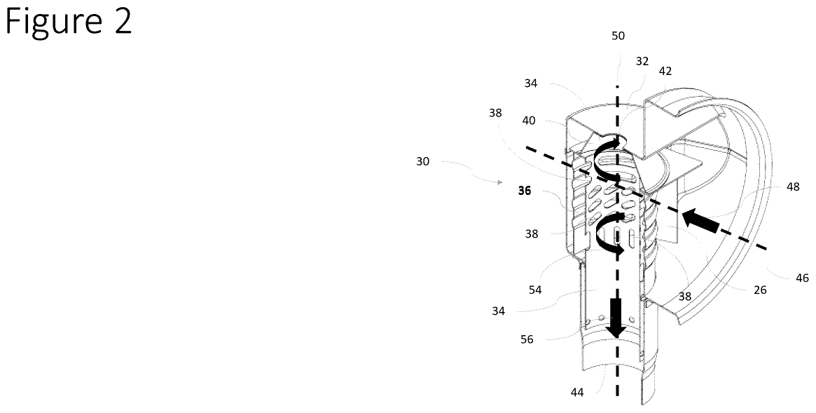

FIG. 2 illustrates an evaporation and gas mixing device of the present invention seen as a 3D like cross section inside a housing (32) for receiving exhaust gas to be processed and mixed. The gas mixing device of the embodiment (30) is located inside a housing (32) having an upstream inlet at arrow (48) for receiving the exhaust gas stream and a downstream outlet (44) for distributing the exhaust gas stream after mixing with the evaporated reductant from dosing inlet (42). The housing (32) has an L-shaped configuration having an upstream inlet for receiving the exhaust gas stream indicated by inlet at arrow (48) which is perpendicular to a downstream outlet for distributing the exhaust gas stream after mixing with the evaporated reductant indicated by a longitudinal axis (50) having an outlet (44). Inside the housing (32) the evaporation and gas mixing device (10, as illustrated in FIG. 1), is located. The evaporation and gas mixing device has a mixing chamber defined by a cylindrical tube (34) and a conical top part (40). The cylindrical tube (34) is designed to regulate swirling flow before leaving the outlet (44). The top conical part (40) of the mixing chamber (34, 40) has an opening at the top (18, FIG. 1) for spraying and distributing a reductant e.g., a liquid reductant, such as an aqueous urea solution, into the exhaust gases when the after-treatment system is in operation in a combustion engine inside a vehicle, such as a diesel truck or the like. When the evaporation and gas mixing device of the present invention (10 in FIG. 1) is in operation the opening (18, FIG. 1) at the top part (40) is equipped with a dosing module arranged at one end of the mixing chamber (34, 40) opposite the outlet (44) of the mixing chamber (34). The top part (40) of the mixing chamber (34, 40) has two first openings (14, 16 as illustrated in FIG. 1) for receiving exhaust gas which is swirled when entering the openings (14, 16). Each of the two openings (14, 16) provides a second guiding means (in this embodiment two second guiding means) adapted to receive and guide the exhaust gas stream into the mixing chamber, wherein said exhaust gas stream is guided perpendicular (46) to the exhaust gas stream (50, 56) being distributed out of the outlet (44) of the mixing chamber, and wherein the top part (40) (the second guiding means) has an opening (18, FIG. 1) for introducing the reductant into the mixing chamber via a dosing module (not shown), wherein the top part opening (18, FIG. 1) is in communication with opening (42) of the housing (32). In the shown embodiment the openings (18, 42) are centred and aligned along the longitudinal axis (50). Typically, the exhaust gas entering the inlets (14, 16) in the top part (40) is swirled clockwise as illustrated by arrow (52) and is mixed with the evaporated reductant via opening (42). The exhaust gas further enters the mixing chamber in the direction as illustrated by arrow (48) via a second inlet opening (26 as in FIG. 1), which inlet (26) receives the exhaust gas via the axis defined by (46) and in the direction shown by arrow (48). The second inlet opening (26) provides a first guiding means (in this embodiment one first guiding means) adapted to receive and guide the exhaust gas stream into the mixing chamber, wherein said exhaust gas stream is guided perpendicular (46) to the exhaust gas stream (50, 56) being distributed out of the at outlet (44) of the mixing chamber. Another option is to swirl the exhaust gas entering the inlets (14, 16) in the top part (40) counter clockwise, if the swirled gas from inlet (26, 48) is swirled clockwise. The upper part of the mixing chamber (34) facing the top conical mixing part (40) is enveloped by an outer spiral (36) where the outer spiral induces the counter clockwise swirling gas stream (54) inside the mixing chamber (34). Typically, and as illustrated the upper part of the mixing chamber (34) have openings or apertures (38) for receiving the exhaust gas when the exhaust gas enters the inlet (26) and is swirled via the space created by the spiral outer part (36) and the mixing chamber (34). The spiral outer part (36) is in direct communication with the inlet (26) and the exhaust gas is swirled upon entering the mixing chamber. The first opening(s) and the second opening (26) are here separated by a shielding element (25, FIG. 1) making sure that the exhaust gas is divided into two separate gas flows when entering the mixing chamber (34, 40) from inlet at arrow (48) (14, 16 in FIGS. 1, 26 and 48 in FIG. 2). Preferably, and as illustrated the first flow part of the exhaust gas enters the top mixing part of the mixing chamber and is swirled clockwise (52) whereas the second flow part of the exhaust gas enters the inlet of the second opening (26) and is swirled counter clockwise (54). The swirling creates a high velocity flow to aid in evaporation and the opposing swirling directions ensures good mixing of gaseous species.

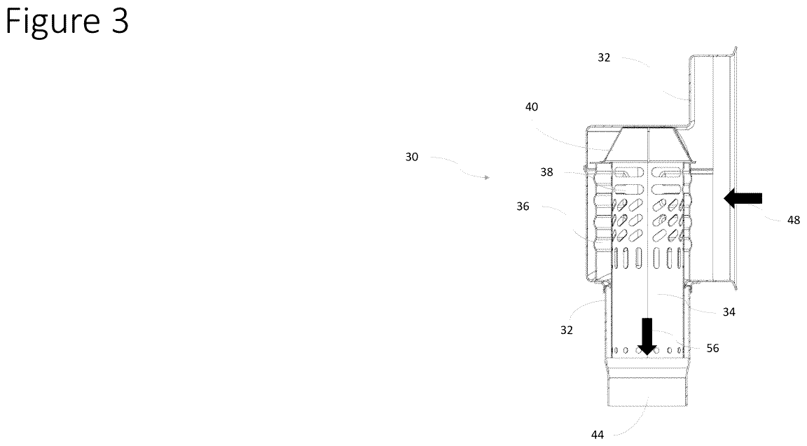

FIG. 3 is a cross sectional view of the liquid evaporation and gas mixing device of the present invention as shown in FIGS. 1 and 2. In particular, the exhaust gas enters the housing (32) in the direction shown with arrow (48). The exhaust gas is then split into two gas flows. First exhaust gas flow enters the evaporation and mixing device through the top swirling device (40) inlet (14, 16 FIG. 1) and the gaseous flow is accelerated around the point of injection with an aid of the top swirling device (40) which aids in evaporation and mixing between gas and reductant. The reductant is typically aqueous urea solution which is introduced into the exhaust gas as a spray via a reductant dosing module substantially perpendicular to the exhaust gas entry axis (46). The exhaust gas carrying gaseous ammonia and liquid droplets from the top swirling device (40) passes to the inner tube (34) in a clockwise swirling direction. Second, exhaust gas flow enters the evaporation and mixing device through the swirling device inlet (26) into the mixing chamber (34) which is in direct communication with the top swirling device (40). The gaseous flow is accelerated around inner tube (34) with the aid of the swirling device (36), and the accelerated gaseous flow passes through the inner tube and out via outlet (44), which causes the flow to adopt a (high velocity) swirling motion which aids in evaporation and mixing in a second direction. Typically, and as illustrated the upper part of the mixing chamber (34) have openings or apertures (38) for receiving the exhaust gas when the exhaust gas enters the inlet (26 in FIG. 2) and is swirled via the space created by the spiral outer part (36) and the mixing chamber (34). The pipe extension helps avoid deposition in mixer outlet (44). When the first and second gas flows of the exhaust gas from the top swirling device and lower swirling device mixes within the inner tube and is forced towards the mixer outlet retaining a swirling motion in a clockwise or counter clockwise direction. The present invention may be used in connection with distribution, deflection and swirling baffle and continues through a SCR catalyst. After leaving the outlet (44) and the mixing chamber (inner tube) (34) the gaseous flow is reversed 180° in a distribution unit (not shown), with the flow deflecting device. Hereafter, the gaseous flow passes through a swirling baffle (not shown), which causes the gas flow to adopt a swirling motion which aids in mixing and prevents a low-pressure zone behind the flow deflecting device. The homogeneously mixed gaseous species pass through a selective catalytic reduction catalyst or SCR on filter catalyst to be processed.

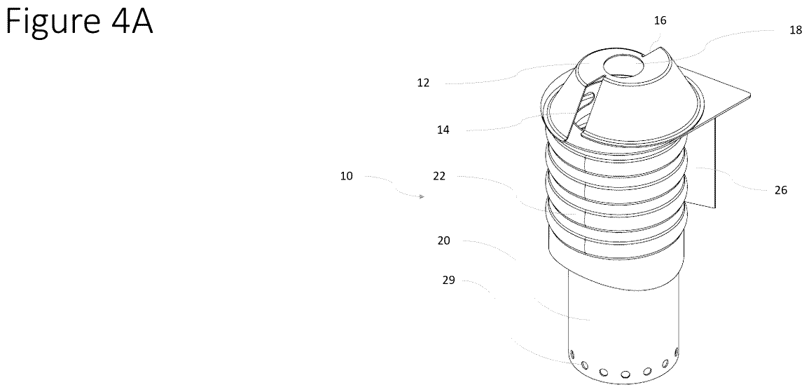

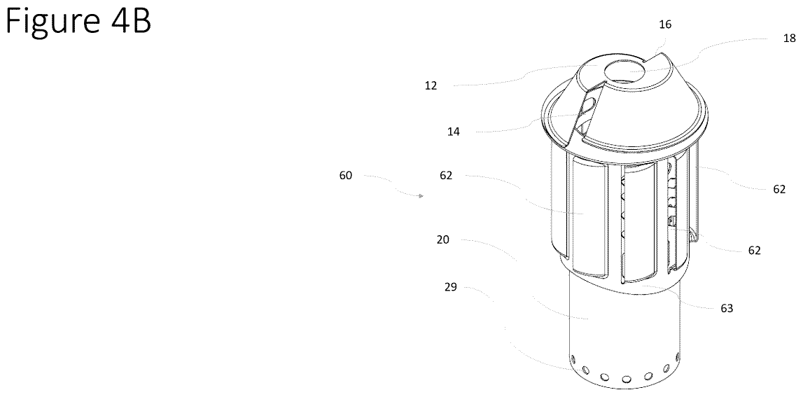

FIG. 4A illustrates, the embodiment (10) in FIG. 1 wherein the conical top part (12) is connected and sealed to the bottom part consisting of the mixing chamber defined by a cylindrical tube (20) and wherein the upper part of the mixing chamber in direct communication with the conical top part is enveloped by an outer spiral (22) where the outer spiral induces the counter clockwise swirling gas stream inside the mixing chamber. The conical top part (12) has two inlets (14, 16) for receiving the exhaust gas and an opening (18) in the top part for introducing the reductant during operation. The mixing chamber has an inner cylindrical tube (20) with apertures (29) in the lower part relieving the low pressure zone near the trailing edge of the cylindrical tube (20) and is enveloped by a spiral outer part (22) in the upper part adapted to receive the exhaust gas via inlet (26) into the spiral outer part, where the exhaust gas is swirled into the mixing chamber through the apertures (38, FIG. 2) in the upper part. Further, provided is a delimiting body (25) separating the exhaust gas into a flow through the top part (12) and another flow through the inlet (26) into the mixing chamber.

FIG. 4B illustrates an alternative to the embodiment in FIG. 1 (60) wherein the mixing chamber has an inner cylindrical tube 20 with apertures (29) in the lower part relieving the low pressure zone near the trailing edge of the cylindrical tube (20) part and is enveloped by an outer part (63) in the upper part adapted to receive the exhaust gas via swirling vanes (62) into the outer part, where the exhaust gas is swirled into the mixing chamber through the through the apertures (38, FIG. 2) in the upper part.

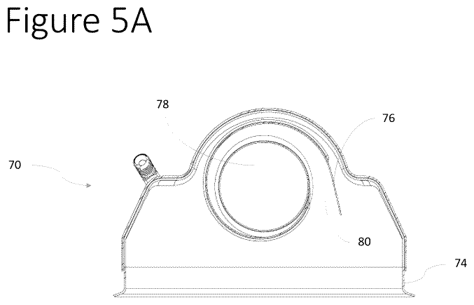

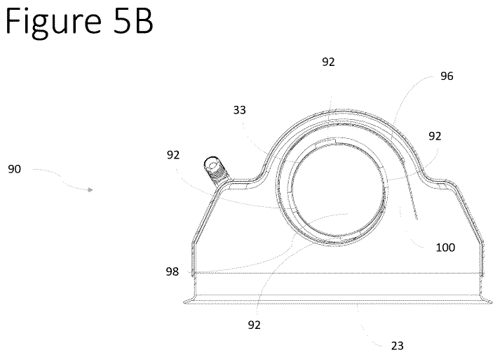

FIG. 5A illustrates, is a top cross sectional view of the liquid evaporation and gas mixing device (70) of the present invention as shown in FIGS. 1 and 2. In particular, the outer spiral (76) where the outer spiral induces the counter clockwise swirling gas stream inside the mixing chamber when entering the opening (80).

FIG. 5B illustrates is a top cross sectional view of the liquid evaporation and gas mixing device (90) of the present invention as shown in FIGS. 1 and 2. In particular, is shown bypass holes (92) as an alternative to the embodiment of FIG. 5A where there are no bypass holes. Such bypass holes are designed to enable heatflux from pipe extension exterior to pipe extension interior.

The liquid evaporation and gas mixing device of the present invention may be made by various production methods, and herein below is one way of making an embodiment of the device described in more detail with reference to the FIGS. 1-5. The conical top part and mixing chamber may each be in four parts wherein the pipe part is laser cut and rolled, the outer spiral is laser cut and rolled, the conical top part is pressed, and the delimiting body is laser cut. The inner pipe is welded on the delimiting body to form a first assembly and the formed outer spiral is welded to the delimiting body of the first assembly subsequently the conical top part is welded to delimiting body of the assembly. Finally the assembled component is fitted and welded in the housing.

All references, including publications, patent applications and patents, cited herein are hereby incorporated by reference to the same extent as if each reference was individually and specifically indicated to be incorporated by reference and was set forth in its entirety herein.

All headings and sub-headings are used herein for convenience only and should not be construed as limiting the invention in any way.

Any combination of the above-described elements in all possible variations thereof is encompassed by the invention unless otherwise indicated herein or otherwise clearly contradicted by context.

Recitation of ranges of values herein are merely intended to serve as a short method of referring individually to each separate value falling within the range, unless otherwise indicated herein, and each separate value is incorporated into the specification as if it were individually recited herein. Unless otherwise stated, all exact values provided herein are representative of corresponding approximate values (e.g., all exact exemplary values provided with respect to a particular factor or measurement can be considered to also provide a corresponding approximate measurement, modified by “about”, where appropriate).

All methods described herein can be performed in any suitable order unless otherwise indicated herein or otherwise clearly contradicted by context.

The terms “a” and “an” and “the” and similar referents as used in the context of describing the invention are to be construed to insert both the singular and the plural, unless otherwise indicated herein or clearly contradicted by context. Thus, “a” and “an” and “the” mean at least one, or one or more, which can be used interchangeably.

The term “and/or” as used herein is intended to mean both alternatives as well as each of the alternatives individually. For instance, expression “xxx and/or yyy” means “the xxx and yyy; the xxx; or the yyy”, all three alternatives are subject to individual embodiments.

The use of any and all examples, or exemplary language (e.g., “such as”) provided herein, is intended merely to better illuminate the invention and does not pose a limitation on the scope of the invention unless otherwise indicated. No language in the specification should be construed as indicating any element is essential to the practice of the invention unless as much is explicitly stated.

The citation and incorporation of patent documents herein is done for convenience only and does not reflect any view of the validity, patentability and/or enforceability of such patent documents.

The description herein of any aspect or embodiment of the invention using terms such as “comprising”, “having”, “including” or “containing” with reference to an element or elements is intended to provide support for a similar aspect or embodiment of the invention that “consists of”, “consists essentially of”, or “substantially comprises” that particular element or elements, unless otherwise stated or clearly contradicted by context (e.g., a composition described herein as comprising a particular element should be understood as also describing a composition consisting of that element, unless otherwise stated or clearly contradicted by context).

This invention includes all modifications and equivalents of the subject matter re-cited in the aspects or claims presented herein to the maximum extent permitted by applicable law.

The features disclosed in the foregoing description may, both separately and in any combination thereof, be material for realizing the invention in diverse forms thereof.

1.-16. (canceled)

17. A evaporation and gas mixing device for an exhaust gas after-treatment system, the device is for mixing an exhaust gas stream from the exhaust gas after-treatment system with an evaporated reductant, the device comprising:
a) a housing having an upstream inlet for receiving the exhaust gas stream and a downstream outlet for distributing the exhaust gas stream after mixing with the evaporated reductant,
b) a mixing chamber located inside the housing for swirling the exhaust gas stream and evaporated reductant for mixing inside the chamber having at least one opening for introducing the reductant into the mixing chamber and having at least two separate inlets for receiving the exhaust gas stream and at least one outlet in communication with the downstream outlet of the housing for distributing the exhaust gas stream after mixing with the evaporated reductant,
c) a dosing module for introducing the reductant through the at least one opening into the mixing chamber for evaporation and mixing with the exhaust gas stream, wherein the dosing module is arranged at one end of the mixing chamber opposite the at least one outlet of the mixing chamber,
d) a first guiding means located inside the housing having at least one inlet adapted to receive and guide the exhaust gas stream to the mixing chamber, wherein said exhaust gas stream is guided perpendicular to the exhaust gas stream being distributed out of the at least one outlet of the mixing chamber,
e) a second guiding means located inside the housing and arranged at the one end of the mixing chamber opposite the at least one outlet of the mixing chamber, said second guiding means having at least one inlet adapted to receive and guide the exhaust gas stream to the mixing chamber, wherein said exhaust gas stream is guided perpendicular to the exhaust gas stream being distributed out of the at least one outlet of the mixing chamber, and wherein the second guiding means has an opening for introducing the reductant into the mixing chamber.

18. The device of claim 17 wherein the mixing chamber is adapted to swirl the exhaust gas stream clockwise and/or counter clockwise inside the mixing chamber.

19. The device of claim 17, wherein the first guiding means comprises at least one bypass opening for guiding a part of the exhaust gas stream directly to the downstream outlet of the housing thereby bypassing the mixing chamber.

20. The device of claim 17, wherein the first guiding means comprises a cylindrical tube with multiple openings adapted to induce swirling of the exhaust gas stream, the cylindrical tube being located on an outer periphery of the mixing chamber.

21. The device of claim 17, wherein the first guiding means comprises a spiral shaped tube with at least one opening adapted to induce swirling of the exhaust gas stream, the spiral shaped tube being located on an outer periphery of the mixing chamber.

22. The device of claim 20, wherein the first guiding means induces swirling of the exhaust gas stream clockwise inside the mixing chamber and the second guiding means induces swirling of the exhaust gas stream counter clockwise inside the mixing chamber.

23. The device of claim 20, wherein the first guiding means induces swirling of the exhaust gas stream counter clockwise inside the mixing chamber and the second guiding means induces swirling of the exhaust gas stream clockwise inside the mixing chamber.

24. The device of claim 17, wherein the second guiding means is located on top of the mixing chamber directly opposite the outlet of the mixing chamber and creating a space being a part of the mixing chamber.

25. The device of claim 17, wherein the mixing chamber defines a longitudinal axis from the at least one opening for introducing the reductant into the mixing chamber to the at least one outlet in communication with the downstream outlet of the housing for distributing the exhaust gas stream after mixing with the evaporated reductant.

26. The device of claim 17, wherein the mixing chamber comprises a cylindrical tube with multiple openings in the upper part of the mixing chamber adjacent the dosing module.

27. The device of claim 17, wherein the housing is L-shaped having the upstream inlet for receiving the exhaust gas stream and the downstream outlet for distributing the exhaust gas stream after mixing with the evaporated reductant, wherein said upstream inlet defines a first longitudinal axis and said downstream outlet defining a second longitudinal axis, wherein the first longitudinal axis is substantially perpendicular to the second longitudinal axis.

28. The device of claim 17, wherein the dosing module for introducing the reductant is arranged for introducing the reductant in parallel with the longitudinal axis of the mixing chamber.

29. The device of claim 17, wherein the dosing module selected from a pressure atomizer or an air-assisted atomizer.

30. The device of claim 17, wherein the dosing module further comprises an injection protection attachment.

31. The device of claim 17, further comprising a spray breaking device for impingement of a liquid spray.

32. An after-treatment system of the exhaust gases from a combustion engine comprising at least one device according to claim 17.
